(19) United States
(12) Patent Application Publication
(10) Pub. No.: US 2026/0257496 A1
(43) Pub. Date: Sep. 3, 2026

(54) FIXING DEVICE AND IMAGE FORMING APPARATUS

(71) Applicant: CANON KABUSHIKI KAISHA, Tokyo (JP)

(72) Inventors: TAKUMI NAGATA, Chiba (JP); JUN KAWAKITA, Chiba (JP)

(21) Appl. No.: 19/533,568

(22) Filed: Feb. 9, 2026

(30) Foreign Application Priority Data
Mar. 3, 2025 (JP) 2025-032839

(51) Int. Cl. B41J 11/00; B41J 29/377

(52) U.S. Cl. CPC B41J 11/00222; B41J 11/0005; B41J 11/00242; B41J 11/007; B41J 11/0085; B41J 29/377

(57) ABSTRACT

A fixing device includes a first heating unit, a second heating unit having maximum power consumption smaller than maximum power consumption of the first heating unit, and a control section configured to control power supplied to the first heating unit and the second heating unit, in which the control section stops supply of power to the second heating unit and starts supply of power to the first heating unit in a case where input power exceeds first power and is equal to or smaller than second power larger than the first power, and reduces power input to the first heating unit by starting the supply of the power to the second heating unit while the power is supplied to the first heating unit, in a case where the input power exceeds the second power.

### BACKGROUND

### Field of the Technology

The present disclosure relates to a fixing device for fixing a formed image on a recording material, which is used in an image forming apparatus such as a copying machine, a printer device, a facsimile device, which use an electrophotographic system or an ink jet recording method, or a multifunction peripheral having a plurality of these functions, and an image forming apparatus equipped with the fixing device.

### Description of the Related Art

An image forming apparatus using an electrophotographic system or an ink jet recording method is equipped with a fixing device for fixing an image formed by heat on a recording material such as a recording sheet. Since this fixing device requires optimal temperature control according to a wide range of types of recording materials, toners, and inks, Japanese Patent Application Laid-Open No.2017-138444 proposes a device in which two types of halogen lamp heaters having different maximum power consumption are used in combination so that fine temperature control can be performed.

However, Japanese Patent Application Laid-Open No.2017-138444 has a problem that it is not possible to perform fine temperature control.

### SUMMARY

According to the present disclosure, a fixing device includes a first heating unit, a second heating unit having maximum power consumption smaller than maximum power consumption of the first heating unit, and a control section configured to control power supplied to the first heating unit and the second heating unit, in which the control section stops supply of power to the second heating unit and starts supply of power to the first heating unit in a case where input power exceeds first power and is equal to or smaller than second power larger than the first power, and reduces power input to the first heating unit by starting the supply of the power to the second heating unit while the power is supplied to the first heating unit, in a case where the input power exceeds the second power.

Further features of the present disclosure will become apparent from the following description of exemplary embodiments with reference to the attached drawings.

### BRIEF DESCRIPTION OF THE DRAWINGS

FIG. 1 is a schematic front cross-sectional configuration diagram of an ink jet recording system according to a first embodiment of the present disclosure.

FIG. 2 is a front cross-sectional view illustrating details of a first fixing module according to the first embodiment of the present disclosure.

FIG. 3 is a circuit block diagram of a drive circuit that drives a heater of the first fixing module according to the first embodiment of the present disclosure.

FIGS. 4A to 4C are explanatory views for describing a configuration of a temperature detection sensor of the first fixing module according to the first embodiment of the present disclosure.

FIG. 5 is a graph illustrating a form of heating control of the heater of the first fixing module according to the first embodiment of the present disclosure.

FIG. 6 is a graph illustrating a form of heating control of the heater of the first fixing module according to the first embodiment of the present disclosure.

FIG. 7 is a flowchart illustrating processing of a CPU that performs heating control of the heater of the first fixing module according to the first embodiment of the present disclosure.

FIG. 8 is a flowchart illustrating processing of the CPU that performs heating control of the heater of the first fixing module according to the first embodiment of the present disclosure.

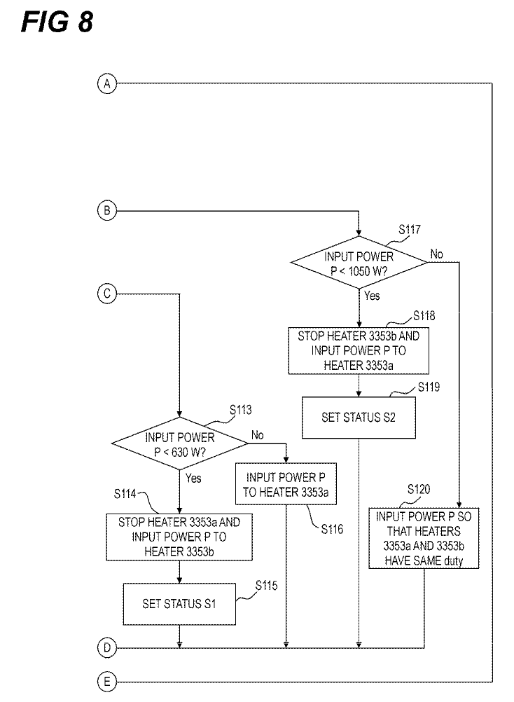

FIG. 9 is a perspective view of a first fixing module according to a second embodiment of the present disclosure.

FIG. 10 is a front cross-sectional view illustrating a schematic configuration of a first fixing module according to a third embodiment of the present disclosure.

### DESCRIPTION OF THE EMBODIMENTS

Hereinafter, preferred embodiments of the present disclosure will be described in detail with reference to the drawings. The constituent elements described in the following embodiments are merely examples, and various conditions such as a configuration, a function, a dimension, a material, a shape, a relative arrangement, and the like of an apparatus to which the present disclosure is applied can be appropriately modified or changed without departing from the gist of the present disclosure, and are not limited to the following embodiments.

### First Embodiment

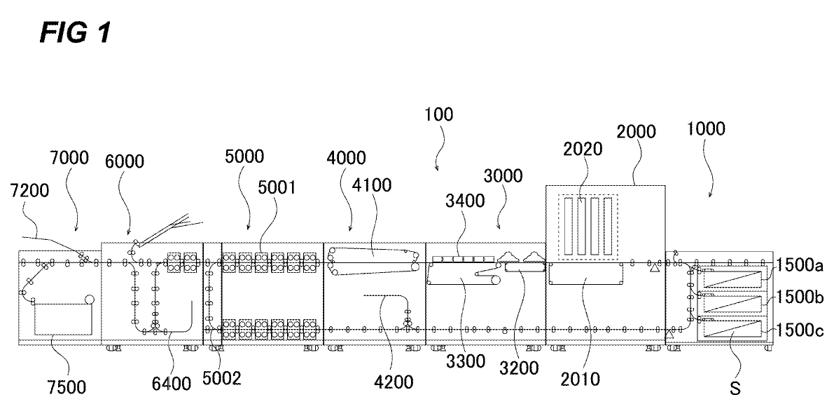

FIG. 1 is a schematic front cross-sectional configuration diagram of an image forming system according to a first embodiment of the present disclosure.

In FIG. 1, an ink jet recording system 100 as an image forming system in the present embodiment uses an ink jet recording method that discharges an ink as a developer and forms an image on a sheet that is a recording material as a recording medium, and is a so-called sheet-fed type ink jet recording apparatus that forms an ink image on a sheet by using two liquids of a reaction liquid and an ink. The sheet may be, for example, a recording material capable of receiving an ink, such as plain paper or thick paper, a plastic film for an overhead projector, a sheet having a special shape such as an envelope or index paper, and cloth.

The ink jet recording system 100 in the present embodiment is an example of an image forming apparatus, and includes a feeding module 1000, a print module 2000, and a first fixing module 3000 as illustrated in FIG. 1. The ink jet recording system 100 further includes a second fixing module 4000, a cooling module 5000, a reversing module 6000, and a stacking module 7000. When a sheet supplied from the feeding module 1000 is conveyed along a conveyance path in each module, various processes are performed, and the sheet is finally ejected to the stacking module 7000.

The feeding module 1000 to the stacking module 7000 may have separate housings, and the ink jet recording system 100 may be configured by joining the housings.

Alternatively, the feeding module 1000, the print module 2000, the first fixing module 3000, the second fixing module 4000, the cooling module 5000, the reversing module 6000, and the stacking module 7000 may be disposed in one housing.

The feeding module 1000 includes storage compartments 1500a, 1500b, and 1500c that accommodate sheets, and the storage compartments 1500a to 1500c are provided to be drawable toward the front side of the apparatus in order to accommodate sheets. Sheets are fed one by one by a separation belt and a conveying roller in each of the storage compartments 1500a, 1500b, and 1500c, and conveyed to the print module 2000. The number of the storage compartments 1500a, 1500b, and 1500c is not limited to three, and may be one, two, or four or more.

The print module 2000 that is an example of an image forming portion as an image forming section, includes a pre-image creation registration correction unit (not illustrated), a print belt unit 2010, and a recording portion 2020, and discharges an ink to a sheet to form an image. The sheet conveyed from the feeding module 1000 is conveyed to the print belt unit 2010 after an inclination and a position are corrected by the pre-image creation registration correction unit (not illustrated). The recording portion 2020 is disposed at a position facing the print belt unit 2010 with respect to the conveyance path of the sheet.

The recording portion 2020 as the image forming section is an ink jet recording portion that forms an image by discharging an ink to a sheet by a recording head from above with respect to the conveyed sheet. A plurality of recording heads that discharges an ink is arranged along a conveyance direction. In the present embodiment, a total of five line type recording heads corresponding to four colors of yellow (Y), magenta (M), cyan (C), and black (Bk), and a reaction liquid are provided. The sheet is attracted and conveyed by the print belt unit 2010, thereby securing a clearance with the recording head.

The number of colors of ink and the number of recording heads are not limited to the above-described five. As the ink jet system, a method using a heat generating element, a method using a piezoelectric element, a method using an electrostatic element, a method using a micro electro mechanical systems (MEMS) element, and the like can be adopted. The ink of each color is supplied from an ink reservoir (not illustrated) to the recording head via an ink tube. The ink contains 0.1 mass% to 20.0 mass% of a resin component, water, a water-soluble organic solvent, a coloring material, wax, an additive, and the like based on the total mass of the ink.

When the sheet on which the image is formed by the recording portion 2020 is conveyed by the print belt unit 2010, the sheet is detected by an in-line scanner (not illustrated) disposed on the downstream side of the recording portion 2020 in the conveyance direction of the sheet. Here, the shift and color density of the image formed on the sheet are detected, and the image to be formed on the sheet, density, and the like are corrected based on the shift and the color density of the image.

The first fixing module 3000 as a fixing device is an example of a drying device, and blows hot air to a sheet on which an image is formed by discharging an ink to dry the sheet. The first fixing module 3000 includes a decoupling portion 3200, a drying belt unit 3300, and a warm air blowing unit 3400. The first fixing module 3000 reduces the liquid content of the ink and the reaction liquid applied to the sheet in order to enhance the fixability of the ink to the sheet by the subsequent second fixing module 4000.

The sheet on which the image is formed is conveyed to the decoupling portion 3200 disposed in the first fixing module 3000. In the decoupling portion 3200, a frictional force is generated between the sheet and the belt by the wind pressure of air blown from above, and the sheet is conveyed by the belt. In this manner, by conveying the sheet placed on the belt by the frictional force, shift of the sheet when the sheet is conveyed over the print belt unit 2010 and the decoupling portion 3200 is prevented.

The sheet conveyed from the decoupling portion 3200 is attracted and conveyed by the drying belt unit 3300, and the hot air is blown from the warm air blowing unit 3400 disposed above the belt to dry the ink and the reaction liquid applied to the sheet.

In this manner, the ink and the reaction liquid applied to the sheet are heated by the first fixing module 3000 to promote evaporation of moisture, so that it is possible to suppress an occurrence of so-called cockling in which the sheet is locally extended and wrinkled by an ink portion applied to the sheet absorbing the ink. As a heater that heats air, for example, heating by an electric heating wire or an infrared heater can be used from the viewpoint of safety and energy efficiency. A drying method may be configured by combining a method of irradiating a sheet surface with an electromagnetic wave (ultraviolet ray, infrared ray, or the like) and a conductive heat transfer method by contact of a heating member in addition to a method of applying hot air.

The second fixing module 4000 as a fixing device includes a fixing belt unit 4100. The fixing belt unit 4100 causes the sheet on which the image is formed conveyed from the first fixing module 3000 to pass between an upper belt unit and a lower belt unit as a heated heating belt to fix the ink of the sheet to the sheet.

The cooling module 5000 includes a plurality of cooling portions 5001, and cools the high-temperature sheet conveyed from the second fixing module 4000 by the cooling portion 5001. The cooling portion 5001, for example, takes outside air into a cooling box by a fan to increase the pressure in the cooling box, and applies air blown out through a nozzle to the sheet by the pressure to cool the sheet. The cooling portion 5001 is disposed on both sides of the conveyance path of the sheet and cools both surfaces of the sheet.

The cooling module 5000 is provided with a conveyance path switching portion 5002. The conveyance path switching portion 5002 switches the conveyance path of the sheet according to a case of conveying the sheet to the reversing module 6000 and a case of conveying the sheet to a duplex conveyance path for duplex printing for forming images on both sides of the sheet.

The reversing module 6000 includes a reversing portion 6400. The reversing portion 6400 reverses the front and back sides of the conveyed sheet and changes the front and back sides of the sheet when the sheet is ejected to the stacking module 7000.

The stacking module 7000 includes a top tray 7200 and a stacking portion 7500, and stacks sheets conveyed from the reversing module 6000.

At time of duplex printing, the sheet is conveyed to a conveyance path below the cooling module 5000 by the conveyance path switching portion 5002. Thereafter, the sheet is returned to the print module 2000 through a duplex conveyance path of the second fixing module 4000, the first fixing module 3000, the print module 2000, and the feeding module 1000. A duplex conveying portion of the second fixing module 4000 is provided with a reversing portion 4200 that reverses the front and back of the sheet. Regarding the sheet returned to the print module 2000, an image is also formed by an ink on the other surface on which no image is formed, and the sheet is ejected from the first fixing module 3000 to the stacking module 7000 via the reversing module 6000.

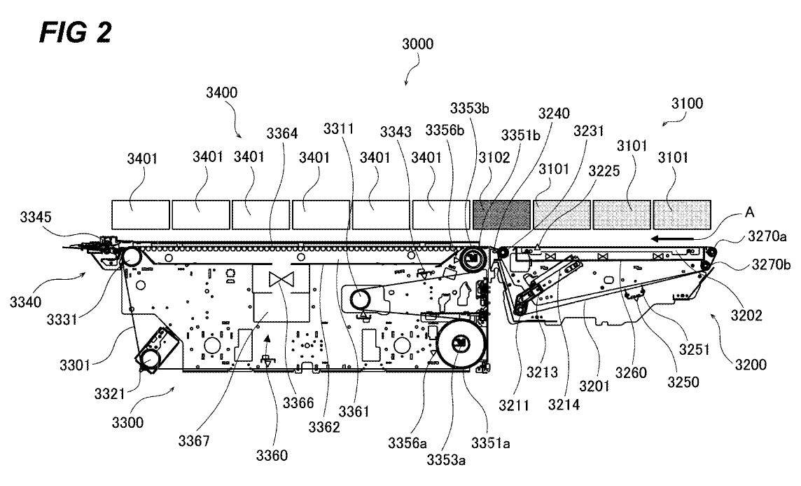

FIG. 2 is a front cross-sectional view illustrating details of the first fixing module 3000 in FIG. 1. In the present embodiment, the first fixing module 3000 is an example of a sheet conveying apparatus that conveys a sheet.

In FIG. 2, in the decoupling portion 3200, a belt 3201 is stretched by a driving roller 3231, a tension roller 3211, and stretching rollers 3270a and 3270b, and a sheet conveying surface of the belt 3201 is supported by a punching metal 3202 from the back surface thereof. The driving roller 3231 and the stretching rollers 3270a and 3270b are rotatably fixed, the tension roller 3211 is rotatably supported by a slide rail 3213 and is displaced in a predetermined direction, and the belt 3201 is biased from the inside by a biasing force of a tension spring 3214, whereby the belt 3201 is stretched.

Further, one end of the tension roller 3211 is supported by a steering arm (not illustrated) that rotates about a rotation portion. Based on a detection result of an edge sensor 3225 that detects the end-portion position of the belt 3201, the amount of rotation of a steering motor having an eccentric steering cam is controlled to rotate the steering arm. As a result, the position of the belt 3201 in a roller axial direction is adjusted to perform meandering regulation.

The belt 3201 has countless holes, and the punching metal 3202 has countless holes smaller than the holes of the belt 3201. The sheet can be attracted onto the belt 3201 by suction of a suction unit 3260 disposed inside the belt 3201, which will be described later. Further, in order to prevent the sheet from uplifting and a suction force from being lowered, the sheet is pressed against the belt 3201 by air blown from a cold air blowing unit 3101 located above to convey the sheet in a sheet conveyance direction A. The air blown from the cold air blowing unit 3101 to a place other than the sheet can be released from the hole of the punching metal. In the present embodiment, the holes of the belt and the holes of the punching metal are provided as holes having equal intervals and circular shapes, and a configuration in which the arrangement intervals are set to be unequal intervals or are provided in a shape other than the circular shape is also effective. In addition, in order to prevent an occurrence of a situation in which the belt 3201 is charged by friction between the sheet and the belt 3201 and an excessive binding force is generated, a charge removing portion 3250 removes charges of the belt 3201 by a charge removal needle 3251.

The sheet conveyed from the decoupling portion 3200 is sent to the drying belt unit 3300 through an inner sheet ejection guide 3240. A belt 3301 of the drying belt unit 3300 is stretched by a driving roller 3331 that is rotatably fixed, heating rollers 3351a and 3351b, a tension roller 3311 that is displaced in a predetermined direction and is rotatably supported, and a steering roller 3321. The belt 3301 is conveyed by rotation of the driving roller 3331.

Regarding the sheet to which the ink is applied, warm air heated by a heater is blown toward the drying belt unit 3300 from a warm air blowing portion 3401 of the warm air blowing unit 3400 disposed above the drying belt unit 3300.

In addition, a suction unit 3360 is provided inside a place of the belt 3301 where the sheet is conveyed, a suction chamber 3361 is formed by a suction duct 3362 and the belt 3301, and a lower fan 3366 exhausts air to an exhaust duct 3367 to generate a negative pressure in the suction chamber 3361.

Since the belt 3301 has countless small holes of about φ0.4, an attraction force is generated on the belt 3301 above the suction unit 3360. The sheet is conveyed while being held on the belt 3301 by the attraction force and the wind pressure from the warm air blowing unit 3400. At this time, in order to support the belt 3301 at a predetermined position, a configuration in which countless rollers 3364 are rotatably arranged in the suction unit 3360, and suction by the fan 3366 is not hindered while the belt 3301 is supported from the inside is adopted.

In the process of conveying the sheet, the ink is dried by blowing warm air from the warm air blowing unit 3400 and heating from the belt 3301. The heating of the belt 3301 is performed by a belt heating portion including a heating roller 3351a and a heating roller 3351b. A halogen heater 3353a as a first heating unit is supported inside the heating roller 3351a. A halogen heater 3353b as a second heating unit is supported inside the heating roller 3351b.

By the temperature detection of a roller temperature detection sensor 3356a and a roller temperature detection sensor 3356b that detect the temperatures of the heating roller 3351a and the heating roller 3351b, an occurrence of a situation in which the heating roller 3351a and the heating roller 3351b reach a predetermined temperature or higher is prevented for safety.

The temperatures of the heating roller 3351a and the heating roller 3351b are increased by heating of the halogen heater 3353a and the halogen heater 3353b. Since heating by the halogen heater 3353a and the halogen heater 3353b consumes a large amount of power, it is necessary to efficiently increase the temperatures of the belt 3301 and the sheet in order to suppress the power consumption of the product. In order to improve the temperature increase efficiency of the belt 3301, it is effective to increase a contact area of the belt 3301 with respect to the heating roller 3351a and the heating roller 3351b. In the present embodiment, the heating roller 3351a is set to have a large diameter of φ113, and the heating roller 3351b is set to have a large diameter of φ58, thereby increasing the contact area.

Heat applied to the belt 3301 is dissipated by contact with the atmosphere or the stretching roller as the belt 3301 is conveyed. Therefore, in order to efficiently transfer heat from the belt 3301 to the sheet, it is effective to dispose the heating roller 3351a and the heating roller 3351b on the upstream side in the belt conveyance direction of a sheet conveyance place of the belt 3301. In the present embodiment, the heating roller 3351b is disposed on the upstream side in the sheet conveyance direction A of the sheet conveyance place of the belt 3301, and the heating roller 3351a is disposed on the further upstream side.

Further, by biasing the belt 3301 from the outside between the heating roller 3351a and the heating roller 3351b by the tension roller 3311, a belt winding angle around the heating roller 3351a and the heating roller 3351b can be made close to 180°. This is to improve the temperature increase efficiency of the belt 3301 and to reduce an influence of variation in a belt stretching posture when the belt 3301 is extended by the temperature increase. In a case where the belt 3301 extends by 20 mm, an entry position of the tension roller 3311 only moves by 10 mm, and the winding angle of the belt 3301 around the other rollers does not change largely. As a result, it is possible to achieve both improvement in the temperature increase efficiency of the belt 3301 and improvement in the heat transfer efficiency from the belt 3301 to the sheet, and to stabilize the belt stretched state.

The temperature increase of the belt 3301 is detected by a non-contact belt surface temperature detection sensor 3343 such as an infrared sensor, a difference from a set heating target temperature for a fixing device is determined by a controller, and is reflected in temperature control of the halogen heater 3353a and the halogen heater 3353b.

The belt 3301 may be configured by using a belt made of metal, and since the linear expansion coefficient of a belt made of resin or rubber is larger, the effect of extending the belt 3301 is large. Therefore, in the present embodiment, a belt made of resin is used as the belt 3301, and a configuration using a belt that is made of metal and has high durability and a large heat capacity may be adopted.

The sheet is heated by the temperature increase via the belt 3301 and the warm air from the warm air blowing unit 3400, conveyed to an inner sheet ejection unit 3340, and then ejected to the second fixing module 4000 by an inner sheet ejection roller 3345.

As the first fixing module 3000, the temperature of the drying belt unit 3300 is increased to about 80°C by the warm air blowing portion 3401, the heating roller 3351a, and the heating roller 3351b. However, a configuration in which the decoupling portion 3200 blows not-heated air from an air blowing portion 3100 at an upper part, and a blowing unit 3102 provided at an upper portion of a connection portion with the drying belt unit 3300 exhausts and sucks the not-heated air to circulate air and block the warm air from the warm air blowing unit 3400 is adopted, and thus there is no large temperature increase and the influence is limited.

In the above embodiment, a belt heating portion is configured by two rollers of the heating roller 3351a and the heating roller 3351b, and a configuration of providing a roller or a heating portion for heating in addition to the two rollers may be adopted.

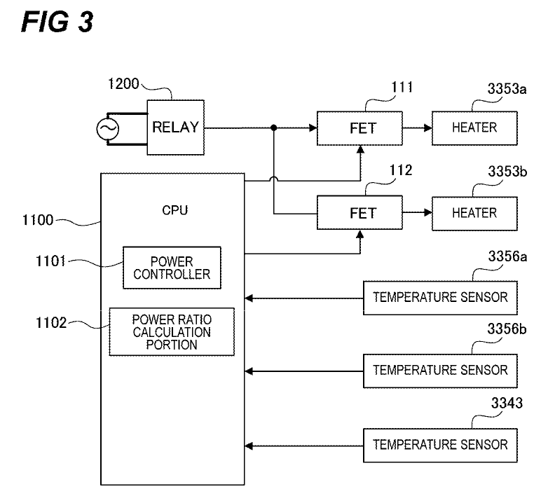

FIG. 3 is a circuit block diagram of a drive circuit that drives the halogen heater 3353a and the halogen heater 3353b of the first fixing module 3000 in FIG. 2.

In FIG. 3, the drive circuit that drives the halogen heater 3353a and the halogen heater 3353b includes a CPU 1100, a relay 1200, an FET 111, an FET 112, a halogen heater 3353a and a halogen heater 3353b, a temperature detection sensor 3356a, a temperature detection sensor 3356b, a temperature detection sensor 3343, a power controller 1101, and a power ratio calculation unit 1102. The CPU 1100 drives the FET 111 and the FET 112 by ON/OFF control on the FET 111 and the FET 112 to drive and control the halogen heater 3353a and the halogen heater 3353b.

The CPU 1100 as a control section can change the power ratio of the heater by the power controller 1101 that controls the power of the halogen heater 3353a and the halogen heater 3353b by PWM. In addition, the power ratio calculation unit 1102 that calculates a power ratio of the heater is included, and the power ratio of the heater is calculated according to the temperature detected by the temperature detection sensor 3343. The temperature detection sensor 3343 detects the temperature of the belt 3301. The temperature detection sensor 3356a and the temperature detection sensor 3356b are safety sensors that detect the temperature of the belt area heated by the halogen heater 3353a and the halogen heater 3353b, respectively, and detect whether the temperature does not reach a predetermined temperature or higher.

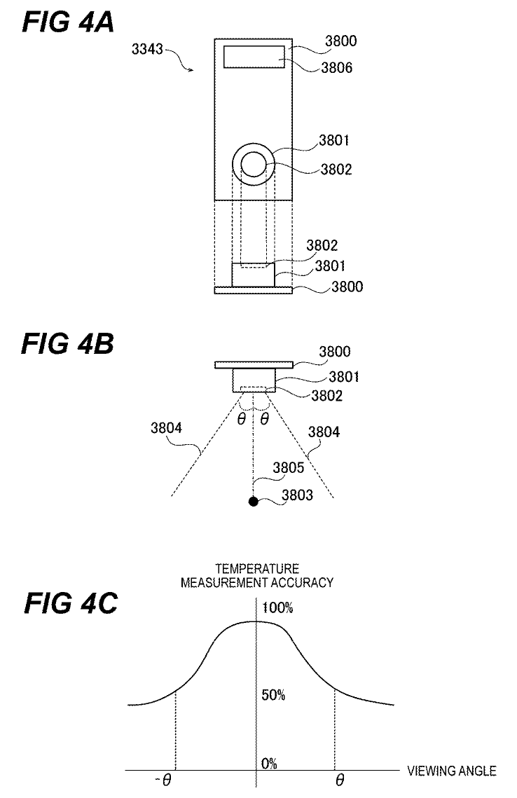

FIG. 4 is an explanatory view illustrating a configuration of the temperature detection sensor 3343, FIG. 4A is an outer view of the temperature detection sensor 3343, and FIGS. 4B and 4C are explanatory views illustrating a viewing angle of the temperature detection sensor 3343.

In FIG. 4A, a package 3801 is a package in which a sensor module is incorporated, is mounted on a board 3800, and has a detection window 3802 at an upper portion. The temperature detection sensor 3343 enables non-contact temperature detection by absorbing infrared rays emitted from a measurement target object from the detection window 3802 and converting the absorbed infrared energy into an electric signal. Further, the temperature detection sensor 3343 can output a result of detection by the package 3801 from a connector 3806. In the present embodiment, the package 3801 that actually detects the temperature is disposed on the most end-portion side of the board 3800 among components mounted in the board 3800.

FIG. 4B is a view schematically illustrating a viewing angle of the temperature detection sensor 3343. In FIG. 4B, the detection window 3802 not only causes infrared rays to pass into the package 3801 but also serves as a lens. That is, the temperature detection sensor 3343 has a predetermined viewing angle 3804, and detects the temperature of a measurement target 3803 within the viewing angle 3804 in a non-contact manner.

FIG. 4C is a view illustrating the definition of the viewing angle 3804. In FIGS. 4B and 4C, the temperature measurement accuracy when the measurement target 3803 is present on a center line 3805 of the viewing angle 3804 is set to 100%. Then, the measurement target 3803 is moved from the center line 3805 without changing a distance to the temperature detection sensor 3343. An angle θ formed by the measurement target 3803 and the center line 3805 when the temperature measurement accuracy is lowered to 50% due to this movement is defined as the viewing angle 3804. This value of 50% is merely an example, and is not limited to 50%.

Next, heating control of the halogen heater 3353a and the halogen heater 3353b in the present embodiment will be described.

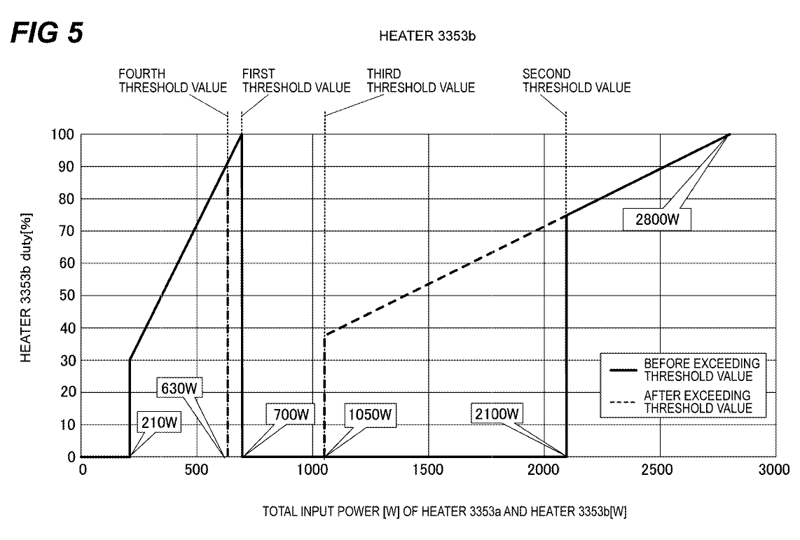

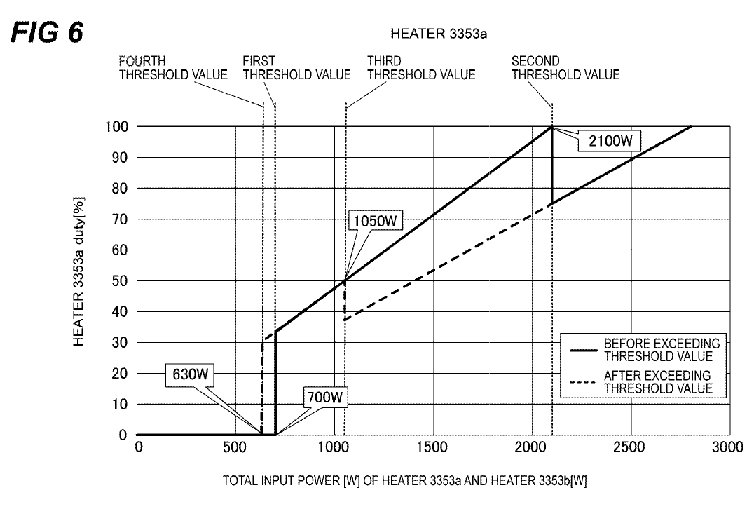

FIGS. 5 and 6 are graphs showing forms of heating control of the halogen heater 3353a and the halogen heater 3353b. In FIG. 5, input power to the halogen heater 3353b with respect to the total input power to the halogen heater 3353a and the halogen heater 3353b is indicated by duty. In FIG. 6, input power to the halogen heater 3353a with respect to the total input power to the halogen heater 3353a and the halogen heater 3353b is indicated by duty. Here, the duty represents the time ratio of the maximum output of the heater in percent, and the maximum power consumption of the halogen heater 3353a and the halogen heater 3353b is 2100 W and 700 W, respectively. Further, since the minimum power consumption for preventing the chemical attack of the halogen heater 3353b is about 0.3 times the maximum power consumption of the heater, the halogen heater 3353b having the maximum power consumption of 700 W has the minimum power consumption of 210 W.

Operations of the halogen heater 3353a and the halogen heater 3353b when the total input power to the halogen heater 3353a and the halogen heater 3353b increases from 0 will be described with reference to FIGS. 5 and 6.

As illustrated in FIG. 5, the halogen heater 3353b is turned on from the total input power of 210 W, which is the minimum power consumption for preventing the chemical attack of the halogen heater 3353b, and only the halogen heater 3353b is duty-controlled.

Further, when the total input power reaches 700 W that is first power, as illustrated in FIGS. 5 and 6, the halogen heater 3353b is stopped, the halogen heater 3353a is turned on, and only the halogen heater 3353a is duty-controlled.

When the total input power reaches 2100 W that is second power, as illustrated in FIGS. 5 and 6, the halogen heater 3353b is turned on in addition to the halogen heater 3353a, and duty of the halogen heater 3353a and duty of the halogen heater 3353b are controlled to be equal to each other. That is, when the input power reaches 2100 W that is a second threshold value, the halogen heater 3353a lowers the duty to 75% as illustrated in FIG. 6, and the halogen heater 3353b is turned on with the duty of 75% as illustrated in FIG. 5, and the total input power to the halogen heater 3353a and the halogen heater 3353b is set to 2100 W in a state where the duties of the halogen heater 3353a and the halogen heater 3353b are equal to each other. Thereafter, control is performed such that the duties of the halogen heater 3353a and the halogen heater 3353b are equal to each other according to the increase or decrease of the input power, and a predetermined amount of heat is applied.

As a result, when switching from one heater to two heaters is performed, fine power control can be performed on the heater without being restricted by the maximum power consumption of the heater or the minimum power consumption for preventing the chemical attack.

Next, the operations of the halogen heater 3353a and the halogen heater 3353b when the total input power decreases from 2800 W will be described.

In FIGS. 5 and 6, when the total input power of the halogen heater 3353a and the halogen heater 3353b decreases from 2800 W and the applied voltage reaches 1050 W that is a third threshold value, the halogen heater 3353b is stopped, and only the halogen heater 3353a is duty-controlled.

As described above, the threshold value of the applied voltage in a case of switching from a state where both the halogen heater 3353a and the halogen heater 3353b are turned on to a state where only the halogen heater 3353a is turned on by switching between the state where both the halogen heater 3353a and the halogen heater 3353b are turned on and the state where only the halogen heater 3353a is turned on is made lower than the threshold value of the applied voltage in a case of switching from the state where only the halogen heater 3353a is turned on to the state where both the halogen heater 3353a and the halogen heater 3353b are turned on to have hysteresis.

By providing hysteresis to the threshold value for switching between the state where both the halogen heater 3353a and the halogen heater 3353b are turned on and the state where only the halogen heater 3353a is turned on at the time of increasing the input power and decreasing the input power as described above, an unstable situation in which switching between the state where both the halogen heater 3353a and the halogen heater 3353b are turned on and the state where only the halogen heater 3353a is turned on is repeatedly performed near the threshold value, and the heater switching or the output is not stabilized, and the heating temperature of the heater does not converge to a target temperature can be prevented.

Further, when the applied voltage reaches 630 W that is a fourth threshold value, the halogen heater 3353a is stopped, and the halogen heater 3353b is turned on. Also in this case, the switching from the halogen heater 3353a to the halogen heater 3353b is performed at a threshold value lower than a switching threshold value from the halogen heater 3353b to the halogen heater 3353a when the input power increases, so that hysteresis is imparted to the switching threshold value, and it is possible to prevent an unstable situation in which the heater is repeatedly switched near the threshold value, the heater switching or the output is not stabilized, and the heating temperature of the heater does not converge to the target temperature.

Finally, when the applied voltage reaches 210 W that is the minimum power consumption for preventing the chemical attack of the halogen heater 3353b, the halogen heater 3353b is stopped.

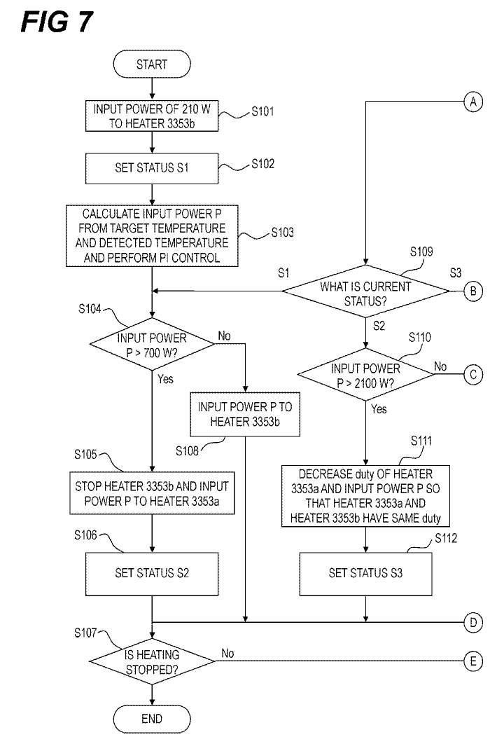

Next, processing of the CPU 1100 in FIG. 3 for performing the heating control of the halogen heater 3353a and the halogen heater 3353b will be described with reference to the flowchart of FIG. 7.

First, when the image forming apparatus starts an operation, in Step S101, the input power P is supplied to the halogen heater 3353b. Here, the minimum power consumption of 210 W for preventing a chemical attack is supplied to the halogen heater 3353b, as the input power P.

Then, in Step S102, a status indicating to which of the halogen heater 3353a and the halogen heater 3353b power is currently input is set. Here, a status S1 is set as a status in which power is input only to the halogen heater 3353b. A status in which power is input only to the halogen heater 3353a is a status S2, and a status in which power is input to both the halogen heater 3353a and the halogen heater 3353b is a status S3.

Then, in Step S103, a total value and a power ratio (duty) of the input power P to the halogen heater 3353a and the halogen heater 3353b are calculated from a difference between the temperature detection sensor 3343 of the belt 3301 and the heating target temperature of the belt 3301, and PI control is performed.

Then, in Step S104, in a case where the input power P exceeds 700 W that is a first threshold value, the supply of the input power P to the halogen heater 3353a is stopped, and the input power P is switched to the supply to the halogen heater 3353a. In Step S106, the status S2 indicating that the supply of the input power P has been switched from the halogen heater 3353a to the halogen heater 3353b is set, and the process proceeds to Step S107.

On the other hand, if the input power P is 700 W or less in Step S104, a supply destination of the input power P is the halogen heater 3353b as it is in Step S108, the status is also kept at S1, and the process proceeds to Step S107.

In Step S107, in a case where heating is stopped as the operation of the image forming apparatus is ended, the operation is ended, and otherwise, the process proceeds to Step S109.

In Step S109, it is determined what situation the current status is in. In the case of the status S1, the process proceeds to Step S104. In the case of the status S2, the process proceeds to Step S110. In the case of the status S3, the process proceeds to Step S117.

In a case where the process proceeds to Step S110 with the status S2 in Step S109, it is determined in Step S110 whether the input power P exceeds 2100 W that is a second threshold value. If the input power P exceeds 2100 W, in Step S111, the input duty to the halogen heater 3353a is reduced to 75%, and the input power P is supplied so that the halogen heater 3353b has a duty of 75%. Thereafter, PI control is performed so that the duties of the halogen heater 3353a and the halogen heater 3353b are equal to each other. In Step S112, the status S3 indicating that the input power P is supplied to both the halogen heater 3353a and the halogen heater 3353b is set, and the process proceeds to Step S107.

On the other hand, if the input power P is 2100 W or less in Step S110, it is determined in Step S113 whether the input power P has fallen below 630 W that is a fourth threshold value. If the input power P is less than 630 W, in Step S114, the supply of the input power P to the halogen heater 3353a is stopped, and the input power P is switched to the supply to the halogen heater 3353b. In Step S115, the status S1 indicating that the supply of the input power P is only the halogen heater 3353b is set, and the process proceeds to Step S107.

In addition, if the input power P is 630 W or more in Step S113, a supply destination of the input power P is the halogen heater 3353a as it is in Step S116, the status remains S2, and the process proceeds to Step S107.

In a case where the process proceeds to Step S117 with the status S3 in Step S109, it is determined in Step S117 whether the input power has fallen below 1050 W that is a third threshold value. If the input power P is less than 1050 W, the supply of the input power P to the halogen heater 3353b is stopped in Step S118, and the supply is switched to the supply to only the halogen heater 3353a. In Step S119, the status S2 indicating that the supply of the input power P has been switched to only the halogen heater 3353a is set, and the process proceeds to Step S107.

On the other hand, if the input power P is 1050 W or more in Step S117, the supply destinations of the input power P are both the halogen heater 3353a and the halogen heater 3353b as they are in Step S120, the status is also kept at S2, and the process proceeds to Step S107.

### Second Embodiment

Next, a second embodiment of the present disclosure will be described.

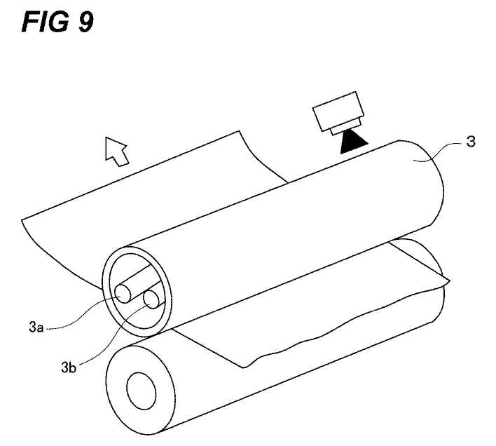

In the first embodiment, two heaters that heat different rollers have been described. However, the present disclosure can also be applied to a case where a plurality of heaters is mounted in one roller. Therefore, in the present embodiment, an example in a case where a plurality of heaters is mounted in one roller will be described with reference to FIG. 9.

FIG. 9 is a perspective view illustrating a configuration of a fixing system in the present embodiment.

In FIG. 9, halogen heaters 3a and 3b are mounted inside a fixing roller 3. The halogen heater 3a and the halogen heater 3b can be controlled similarly to the halogen heater 3353a and the halogen heater 3353b described in the first embodiment, respectively.

### Third Embodiment

Next, a third embodiment of the present disclosure will be described.

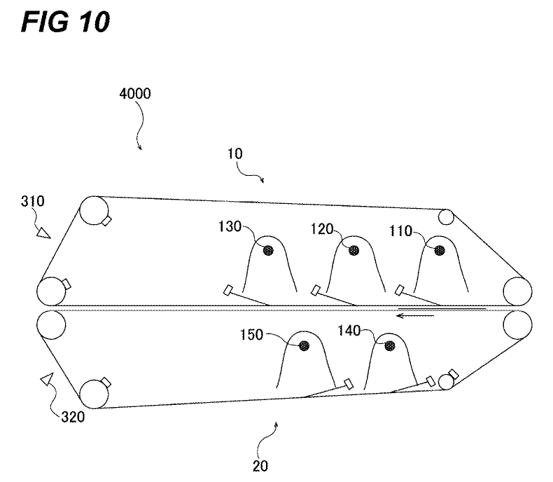

In the first embodiment, the present disclosure is applied to the first fixing module 3000. That is, the control of a plurality of halogen heaters in a plurality of rollers stretching the fixing belt has been performed. However, the second fixing module 4000 in the first embodiment also heats the belt by using a plurality of halogen heaters similarly to the first fixing module 3000. Therefore, in the third embodiment, an example in which the present disclosure is applied in the second fixing module 4000 will be described with reference to FIG. 10.

FIG. 10 is a front cross-sectional view illustrating a schematic configuration of the second fixing module 4000.

In FIG. 10, a halogen heater 110, a halogen heater 120, and a halogen heater 130 are mounted on an upper belt system 10 from the upstream side, a target power ratio (duty) is calculated by PI control from a difference between the belt temperature measured by the temperature detection sensor 310 and the heating target temperature, and the necessary halogen heaters are turned on in order of the halogen heater 110, the halogen heater 120, and the halogen heater 130 according to the power ratio. When the halogen heater 120 is also turned on from a state where only the halogen heater 110 is turned on, the halogen heater 110 and the halogen heater 120 can be controlled similarly to the halogen heater 3353a and the halogen heater 3353b in the first embodiment, respectively. In addition, when the halogen heater 130 is also turned on from a state where the halogen heater 120 is turned on, the halogen heater 120 and the halogen heater 130 can be controlled similarly to the halogen heater 3353a and the halogen heater 3353b in the first embodiment, respectively.

A halogen heater 140 and a halogen heater 150 are mounted on a lower belt system 20 from the downstream side, a target power ratio (duty) is calculated by PI control from a difference between the belt temperature measured by the temperature detection sensor 320 and the heating target temperature, and the necessary halogen heaters are turned on in order of the halogen heater 140 and the halogen heater 150 according to the power ratio. When the halogen heater 150 is also turned on from a state where only the halogen heater 140 is turned on, the halogen heater 140 and the halogen heater 150 can be controlled similarly to the halogen heater 3353a and the halogen heater 3353b in the first embodiment, respectively.

According to the present disclosure, in a fixing device that controls a heating temperature by a combination of a plurality of heating units, it is possible to provide a fixing device that can finely perform heating temperature control in the combination of the plurality of heating units, and an image forming apparatus equipped with the fixing device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-032839, filed March 3, 2025, which is hereby incorporated by reference herein in its entirety.

What is claimed is:

1. A fixing device comprising:
a first heating unit;
a second heating unit having maximum power consumption smaller than maximum power consumption of the first heating unit; and
a control section configured to control power supplied to the first heating unit and the second heating unit, wherein
the control section
stops supply of power to the second heating unit and starts supply of power to the first heating unit in a case where input power exceeds first power and is equal to or smaller than second power larger than the first power, and reduces power input to the first heating unit by starting the supply of the power to the second heating unit while the power is supplied to the first heating unit, in a case where the input power exceeds the second power.

2. The fixing device according to claim 1, wherein
the control section
starts the supply of the power to the second heating unit while the power is supplied to the first heating unit up to the maximum power consumption of the first heating unit, in a case where the input power exceeds the second power.

3. The fixing device according to claim 1, wherein
the control section
reduces the power supplied to the first heating unit such that a ratio of the power supplied to the first heating unit with respect to the maximum power consumption of the first heating unit is the same as a ratio of the power supplied to the second heating unit to the maximum power consumption of the second heating unit, when the supply of the power to the second heating unit is started while the power is supplied to the first heating unit.

4. The fixing device according to claim 3, wherein
when the supply of the power to the second heating unit is started while the power is supplied to the first heating unit, the control section
performs control such that the power supplied to the first heating unit and the power supplied to the second heating unit have the same ratio with respect to the maximum power consumption of each of the first heating unit and the second heating unit from a state where the power supplied to the first heating unit is reduced such that the ratio of the power supplied to the first heating unit with respect to the maximum power consumption of the first heating unit is the same as the ratio of the power supplied to the second heating unit with respect to the maximum power consumption of the second heating unit.

5. The fixing device according to claim 1, wherein
the control section
calculates a power ratio between the power input to the first heating unit and the power input to the second heating unit, from a heating target temperature of the fixing device and a temperature detected by a temperature detection section configured to detect a heating temperature of the fixing device.

6. The fixing device according to claim 1, wherein the first heating unit and the second heating unit include a halogen heater.

7. An image forming apparatus comprising:
an image forming section configured to form an image on a recording material; and
the fixing device according to claim 1, the fixing device being configured to fix the image formed by the image forming section to the recording material.
